(19) United States
(12) Patent Application Publication
(10) Pub. No.: US 2021/0142309 A1
(43) Pub. Date: May 13, 2021

(54) VENDING METHOD CAPABLE OF SUPPORTING THE VENDING MACHINE WITH ID RECOGNITION FUNCTION

(71) Applicant: YALLVEND Co., Ltd, Taipei (TW)

(72) Inventors: Chien Yao Huang, Taipei (TW); Yu En Lee, Taipei (TW); De Cheng Liu, Taipei (TW)

(73) Assignee: YALLVEND Co., Ltd, Taipei (TW)

(21) Appl. No.: 17/089,218

(22) Filed: Nov. 4, 2020

Related U.S. Application Data
(60) Provisional application No. 62/931,923, filed on Nov. 7, 2019.

(51) Int. Cl. G06Q 20/20; G06K 19/06; G06Q 20/32; G06Q 50/26; G06K 7/10; G06K 9/00; G07D 11/22; G07D 11/60

(52) U.S. Cl. CPC G06Q 20/206; G06K 19/06112; G06K 19/06037; G06Q 20/3276; G06Q 50/265; G07D 11/60; G06Q 20/204; G06K 9/00288; G06K 9/00255; G07D 11/22; G06K 7/10297

(57) ABSTRACT

A vending method capable of supporting vending machine with identity (ID) recognition function, suitable for a vending machine for verifying an identity of a consumer, and the method comprises steps of: generating a digital information on the vending machine; enabling an identity recognition application according to the digital information; enabling an image capture unit of a mobile device through the identity recognition application to capture a current head portrait of the consumer; and determining if the consumer passing through an identity recognition by using the identity recognition application; wherein, if the consumer passes through the identity recognition, enabling a sale function of the vending machine.

### FIELD OF THE INVENTION

The present invention relates to a vending machine, and more particularly to a vending machine with ID recognition function.

### BACKGROUND OF THE INVENTION

Various countries generally have stricter controls on controlled products or items. The sale or delivery of controlled products cannot be carried out through automatic vending machines, and human identification must be carried out to facilitate the flow of control. For example, all countries have restrictions on the age of purchase of tobacco and alcohol. Taking Japan as an example, if consumers want to buy tobacco and alcohol on an automatic vending machine, they must first apply for a special and dedicated identity card at the official institution. Before buying, inserting the identity card in the vending machine to buy alcohol and tobacco from the vending machine.

There are also automatic vending machines in some countries that scanning an ID card for identity recognition. However, since the specifications of ID cards in different countries are different, it is impossible to use a same card reader to verify ID cards in all countries.

In view of this special requirement, how to use the old vending machines and the development trend of digital identity to solve the sales of controlled products or items is actually a problem that the technical person in the field is eager to solve.

### SUMMARY OF THE INVENTION

The present invention provides a vending method capable of supporting vending machine with identity (ID) recognition function, suitable for a vending machine for verifying an identity of a consumer, and the method comprises steps of: generating a digital information on the vending machine; enabling an identity recognition application according to the digital information; enabling an image capture unit of a mobile device through the identity recognition application to capture a current head portrait of the consumer; and determining if the consumer passing through an identity recognition by using the identity recognition application; wherein, if the consumer passes through the identity recognition, enabling a sale function of the vending machine.

The present invention adopts digital identity to perform recognition, the consumer do not have to leave the biological characteristics of the consumer in the vending machine, but performing the ID recognition by connection with the government through the network. After the vending machine receives the information of passing the ID recognition, the consumer can use cash, mobile payment or online payment to buy products or items.

If the government does not provide the ID recognition service, the present invention can also use an identity recognition application (APP). On the first use, the consumer has to register in advance. A passport information can be shot and keep in the ID recognition application. Using the connection tool (such as NFC) to sense the chip of the passport and ensure that the information of the passport page is right. Then, when the consumer want to buy the controlled item in the vending machine, the consumer only have to turn on the ID recognition application. The ID recognition application will enable the camera to shoot the head portrait of the consumer to perform the ID recognition. When the vending machine receives that the ID recognition is passed, the consumer can buy items by cash, mobile payment or online payment.

The method of the present invention is suitable for any items required to be controlled such as tobacco and alcohol vending machine, the distribution of controlled drugs, the distribution of detoxification drugs, and service, space and equipment only for specified member. Through the method of the present invention, the controlled item can be placed in the vending machine, which can implement the ID recognition request of the controlled item, and save the manpower.

### BRIEF DESCRIPTION OF THE DRAWINGS

FIG. 1 is a flow chart of the vending machine according to an embodiment of the present invention.

FIG. 2 is a flow chart of ID recognition of the vending machine according to an embodiment of the present invention.

FIG. 3 is a detail flow chart of the ID recognition process of the vending machine.

FIG. 4 is a detail operation flow chart after a consumer passing through the identity recognition.

### DETAILED DESCRIPTION OF PREFERRED EMBODIMENTS

The following will give a detailed description of the embodiments of the present invention. Although the present invention will be described in connection with the embodiments, it should be understood that this does not mean that the present invention is limited to these embodiments. On the contrary, the present invention is intended to cover various changes, modifications and equivalents defined within the spirit and scope of the present invention as defined by the claims of the present invention.

In addition, in the following detailed description of the present invention, in order to provide a fully understanding of the present invention, a large number of specific details are provided. However, those skilled in the art will understand that the present invention can also be implemented without these specific details. In some other embodiments, well-known methods, procedures, components, and circuits are not described in detail, so as to highlight the subject of the present invention.

FIG. 1 is a flow chart of the vending machine according to an embodiment of the present invention. In the step S0, the vending machine is in a standby mode, in the step S2, the vending machine determines if an abnormal situation is generated. If the abnormal situation is generated, disabling the vending machine such that the vending machine cannot perform transaction and informing the trade back platform (the step S4). If the vending machine is normal, continuously detecting if a transaction requirement is generated. The vending machine determines if an ID of a consumer is effective (the step S6). If the vending machine determines that the ID is failed or invalid, disabling all cash sensor and mobile payment (the step S8) in order to prevent a controlled item is bought.

On the contrary, if the vending machine determines that the ID is successful and effective, enabling all cash sensor and mobile payment (the step S10). Then, the vending machine confirms that if a payment system (including the cash and mobile payment) operates normally (the step S12). If the payment system is abnormal and cannot operate normally, returning to the step S4 and terminating the transaction.

If the payment system operates normally, according to the normal transaction flow of the vending machine (the step S14), the consumer pay with a corresponding cash or using mobile payment, the vending machine output an item according to the selection of the consumer, and finish the transaction (S16), and the vending machine returns to the standby mode (the step S10).

Then, with reference to FIG. 2, and FIG. 2 is a flow chart of ID recognition of the vending machine according to an embodiment of the present invention. In the transaction process of the controlled item, in the standby status (the step S0), before the cash sensor receives an effective ID recognition (Sc), the cash senor is under a disable status (the step S1) in order to prevent the controlled item is purchased by a consumer.

When a consumer wants to purchase controlled item, the consumer has to show the proof of the identity. Therefore, the vending machine starts the ID recognition function (the step S300). Then, waking up the ID recognition application (the step S310), and enabling a camera to shoot a head portrait of the consumer (the step S320).

After obtaining the head portrait of the consumer, uploading the head portrait of the consumer and a consumer profile to an ID recognition website (the step S330). In one embodiment, the ID recognition website can include an ID recognition organization constituted by the government. The consumer has to register on the ID recognition website and set up the consumer file in order to facilitate for the ID recognition. However, the present invention is not limited. After the ID recognition website determines that the uploaded head portrait of the consumer is matched with the consumer profile, and confirms the consumer is the person himself, returns an ID recognition result (the step S340). If the ID recognition is not passed, the transaction is canceled (the step S342), and prohibiting the consumer to buy the controlled item. If the ID recognition is passed, enter a normal transaction process of the vending machine. For example, enabling the cash sensor and mobile payment function (the step S10) of the vending machine, after determining the payment method (the step S100).

With further reference to FIG. 3, and FIG. 3 is a detail flow chart of the ID recognition process of the vending machine. After the vending machine turns on the ID recognition function (S300), the vending machine generates a digital information corresponding to the information of the purchased item (S302) such as a QR Code or a two-dimensional barcode. However, the present invention is not limited. The consumer can use the camera function of the cell phone to scan the digital information (the step S304) such as the QR code to turn on a sale application program (the step S306). In one embodiment, the application program can be a cell phone application (APP) or a website. However, the present invention is not limited.

Then, the sale application program can wake up the ID recognition application (the step S310). It can be understood that the ID recognition application can be another cell phone application (APP) or a web page, and the present invention is not limited. As descried above, when the ID recognition application is waked up, enabling the camera of the cell phone of the consumer to shoot the head portrait of the consumer (the step S320). After obtaining the head portrait of the consumer, uploading the head portrait of the consumer to the ID recognition web site (the step S330) to verify the identity of the consumer. The ID recognition web site determines that if the consumer is a qualified buyer for the controlled item, and sending the result of the ID recognition to the vending machine (the step S332) to verify the identity (S340). If the ID recognition is passed, sending the result of the ID recognition to the vending machine (the step S344). At this time, the vending machine performs a normal transaction process. For example, the vending machine enables the cash sensor and the mobile payment function (the step S10), and determining the payment way (the step S100). On the contrary, if the ID recognition is not passed, the transaction is cancelled (the step S342).

It can be understood that if the government provides an ID recognition service, the consumer does not have to leave the biological characteristics of the consumer in the vending machine, but performing the ID recognition by connection with the government through the network. After the vending machine receives that the ID recognition is passed (such as the step S340 in FIG. 2 or the step S344 in FIG. 3), the consumer can select using cash, mobile payment or online payment to obtain the controlled item.

In another embodiment, if the government does not provide the ID recognition service, the consumer has to register in advance before buying the controlled item. For example, a passport information can be shot and keep in the ID recognition application. Using the connection tool (such as NFC) to sense the chip of the passport and determine if the personal information registered in the ID recognition application is matched with the passport information. Then, when the consumer wants to buy the controlled item in the vending machine, the consumer only have to scan the digital information related to the controlled item, the sale application program can be waked up to turn on the ID recognition application. The ID recognition application will enable the camera to shoot the head portrait of the consumer to perform the ID recognition. When the vending machine receives that the ID recognition is passed, the consumer can buy items by cash, mobile payment or online payment.

With reference to FIG. 4, and FIG. 4 is a detail operation flow chart after a consumer passing through the identity recognition. When the consumer passing through the identity recognition, the vending machine will determine the payment way of the consumer (the step S100). If a coin sensor detects that the consumer inputs a coin, the vending machine confirms a cash payment, and entering a cash payment process (SA). On the contrary, if the consumer uses the mobile payment, the cloud terminal will determine that if the current status of the vending machine can accept the mobile payment or not. If the vending machine is at an off-line status without connecting the cloud terminal, the mobile payment cannot be processed. If the vending machine is at an on-line status, the cloud terminal will check that if the vending machine is processing the cash payment now. If yes, the mobile payment cannot be processed as well. If the vending machine is at the on-line status without processing the cash payment, the mobile payment can be performed, and entering the mobile payment process (SB).

Using the cash payment as an example, with reference to the cash payment process SA shown in FIG. 4. In one embodiment, in the step S100, when the coin sensor detects that the consumer inputs coin at a cash hole, the controller sends an information signal to the mobile payment processor to indicate that the vending machine will perform a cash payment. After the mobile payment processor receives the information signal, the mobile payment processor sends a request of pausing mobile payment to the cloud terminal (the step S110) to disable the mobile payment function in order to prevent the cash payment and the mobile payment request simultaneously so that the system is conflicting.

Then, according to the money amount (the step S112) sensed by the coin sensor, the controller enable a selection lamp corresponding to the money amount. The item to be sold corresponding to the money amount will light up (the step S114). In one embodiment, each item to be sold has a corresponding selection button. The consumer can press the selection buttons which light up. It should be understood that the selection button is only an example, and will have different designs according to different vending machines such as a digital keyboard. The present invention is not limited.

The controller can determine that if the selection button is pressed and return a selection signal (the step S116). If the controller receives the selection signal, it means that the consumer has chosen an item. The controller will drive a picking unit to take out the chosen item (the step S118) and put the item at an outlet port. On the contrary, if the controller does not receive the selection signal, it means that the consumer is hesitating, then returning to the step S114, and continuously enabling the selection lamp corresponding to the money amount, and waiting the consumer to press the selection button. Or, the consumer wants to cancel this transaction, and chooses to return money. If the controller receives an indication to return the money (the step S117), returning all of the money inputted by the consumer to a cash rejection hole (the step S121).

After the consumer takes the purchased item out, the controller determines the difference of the money between the price of the item and the money amount inputted by the consumer (the step S120). If the difference of the money is greater than 0, a giving change process is performed at the step S121, and the transaction is end (the step S122). Then, in the step S124, the controller will inform the mobile payment processor the content of this transaction. The mobile payment processor will deliver the content of this transaction to the cloud terminal through a transmitter for storing. At the same time, the mobile payment processor will send an enable mobile payment request to the cloud terminal through the transmitter to turn on the mobile payment. In one embodiment, the content of the transaction information can include but not limited to the code of the vending machine, transaction time, transaction fee, transaction item, coin amount, change amount, etc.

Using the mobile payment as an example, in one embodiment, in the step S100, the consumer uses personal mobile device to scan the identification code (for example, not limited, Quick Response Code, QR Code) on the surface of the vending machine. The personal device of the consumer will appear a payment picture (for example, through payment APP or paid website) corresponding to the identification code. The consumer can input suitable amount of money for the price of the item to be bought, and sending a purchasing request. It can be understood that the indication of the identification code is the only identity information of the vending machine. When the cloud terminal receives the purchasing request sent from the personal mobile device of the consumer, the cloud terminal will determine that if the vending machine can perform the mobile payment. If the vending machine cannot perform the mobile payment, terminate the transaction.

When the vending machine is under the mobile payment status. With reference to the mobile payment process SB in FIG. 4. In one embodiment, in the mobile payment process SB, when the cloud terminal receives a purchase request of the customer, the cloud terminal will send a pausing for receiving cash request to the mobile payment processor, and indicating the vending machine to perform the mobile payment. The mobile payment processor disables the coin sensor (the step S210) in order to avoid that the cash payment and the mobile payment will request simultaneously to lead the system to conflict. That is, when a customer wrongly input cash, the coin sensor will ignore, and directly return the cash to the cash rejection hole. The mobile payment processor will simultaneously obtain the money amount inputted from the customer and sending the money signal to the controller (S214).

Then, the controller will enable selection lamp corresponding to the money amount according to the money signal. The item to be sold corresponding to the money amount will light up (the step S216). In one embodiment, each item to be sold has a corresponding selection button. The consumer can press the selection buttons which light up. It should be understood that the selection button is only an example, and will have different design according to different vending machines such as a digital keyboard. The present invention is not limited.

The controller can determine that if the selection button is pressed and return a selection signal (the step S218). If the controller receives the selection signal, it means that the consumer has chosen an item. The controller will drive a picking unit to take out the chosen item (the step S220) and put the item at an outlet port. At the same time, the controller will compare the money amount inputted in the step S212 by the consumer with the money amount corresponding to the selection signal returning in the step S218 to determine that if making change is required (step S221a). If the money amount inputted by the consumer match with the money amount corresponding to the selection signal, then making change is not required. This transaction is end (step S222).

On the contrary, if the money amount inputted by the consumer is over than the money amount corresponding to the selection signal, performing a money refund process for the overpayment (S221b). After the refund process, the transaction is end (step S222). If the controller does not receive the selection signal, it means that the consumer is hesitating. If the cloud terminal does not receive a request for canceling the transaction (the step S223), then returning to the step S216, and continuously enabling the selection lamp corresponding to the money amount, and waiting the consumer to press the selection button.

If the cloud terminal receives a request for canceling the transaction in the step S223, refunding the entire money amount inputted in the step S212 by the consumer (step S225). Then, the transaction is end (the step S222). In another embodiment, if the consumer wants to cancel the transaction, but not sending the canceling request through the personal mobile device, and using the cash rejection button, the controller will send a refund request to the mobile payment processor, and send the refund request to the cloud terminal through a transmitter to perform a refund process. In another embodiment, an online refund process will be performed.

After the transaction of the step S222 is end. In the step S224, the controller will inform the mobile payment processor the content of this transaction. The mobile payment processor will deliver the content of this transaction to the cloud terminal through a transmitter for storing. At the same time, the mobile payment processor will send an enabling mobile payment request to the cloud terminal through the transmitter to turn on the cash payment by enabling the coin sensor. In one embodiment, the content of the transaction information can include but not limited to the code of the vending machine, transaction time, transaction fee, transaction item, coin amount, change amount, etc.

In summary the method of the present invention is suitable for any items required to be controlled such as tobacco and alcohol vending machine, the distribution of controlled drugs, the distribution of detoxification drugs, and service, space and equipment only for specified member. Through the method of the present invention, the controlled item can be placed in the vending machine, which can implement the ID recognition request of the controlled item, and save the manpower.

The above specific embodiment and figures are only common embodiments of the present invention. Obviously, various additions, modifications and substitutions can be made without departing from the spirit and scope of the invention as defined by the claims. Those skilled in the art should understand that the present invention can be changed in form, structure, layout, proportions, materials, elements, components, and other aspects according to specific environment and operation requirements without departing from the principles of the invention. Therefore, the embodiments disclosed here are only for illustration rather than limitation. The scope of the present invention is defined by the appended claims and their legal equivalents, not limited to the previous description.

1. A vending method capable of supporting vending machine with identity (ID) recognition function, suitable for a vending machine for verifying an identity of a consumer, and the method comprises steps of:
generating a digital information on the vending machine;
enabling an identity recognition application according to the digital information;
enabling an image capture unit of a mobile device through the identity recognition application to capture a current head portrait of the consumer; and
determining if the consumer passing through an identity recognition by using the identity recognition application;
wherein, if the consumer passes through the identity recognition, enabling a sale function of the vending machine.

2. The vending method according to claim 1, before the step of generating a digital information, the method further comprises a step of:
disabling a cash sensor of the vending machine.

3. The vending method according to claim 1, before the step of generating a digital information, the method further comprises a step of:
disabling a mobile payment function of the vending machine.

4. The vending method according to claim 1, wherein, the digital information comprises a quick response code (QR code) or a two-dimensional barcode.

5. The vending method according to claim 4, wherein, the digital information is relating to a sale item.

6. The vending method according to claim 1, wherein, the method further comprises a step of:
using the image capture unit of the mobile device to capture the digital information in order to enable the identity recognition application.

7. The vending method according to claim 1, wherein, the step of determining if the consumer passing through an identity recognition by using the identity recognition application comprises a step of uploading the head portrait of the consumer to an ID recognition web site.

8. The vending method according to claim 1, wherein, the step of determining if the consumer passing through an identity recognition by using the identity recognition application comprises a step of leaving a register identity in the identity recognition application and verifying if the head portrait match with the register identity.

9. The vending method according to claim 8, wherein, the step of leaving a register identity in the identity recognition application comprises a step of leaving a passport information page if the consumer in the identity recognition application, and using a connection tool to sense a passport chip of the consumer to ensure that the passport information page match with the passport chip.

10. The vending method according to claim 1, wherein, the method further comprises a step of sending an identity recognition result to the vending machine.

11. The vending method according to claim 1, wherein, the step of enabling a sale function of the vending machine comprises a step of enabling a cash sensor of the vending machine.

12. The vending method according to claim 1, wherein, the step of enabling a sale function of the vending machine comprises a step of enabling a mobile payment function of the vending machine.

13. A vending machine, comprising a vending method as claimed in claim 1.

14. A vending machine, comprising a vending method as claimed in claim 2.

15. A vending machine, comprising a vending method as claimed in claim 3.

16. A vending machine, comprising a vending method as claimed in claim 4.

17. A vending machine, comprising a vending method as claimed in claim 5.

18. A vending machine, comprising a vending method as claimed in claim 6.

19. A vending machine, comprising a vending method as claimed in claim 7.

20. A vending machine, comprising a vending method as claimed in claim 8
